(19) United States
(12) Patent Application Publication
(10) Pub. No.: US 2016/0049149 A1
(43) Pub. Date: Feb. 18, 2016

(54) METHOD AND DEVICE FOR PROACTIVE DIALOGUE GUIDANCE

(71) Applicant: AUDI AG, 85045 Ingolstadt (DE)

(72) Inventor: PETER LACHER, Ingolstadt (DE)

(73) Assignee: AUDI AG, 85045 Ingolstadt (DE)

(21) Appl. No.: 14/779,515

(22) PCT Filed: Mar. 29, 2014
(86) PCT No.: PCT/EP2014/000847

§ 371 Date: Sep. 23, 2015

(30) Foreign Application Priority Data
Apr. 10, 2013 (DE) 10 2013 006 173.3

(51) Int. Cl. G10L 15/22; B60R 16/037; B60K 37/06

(52) U.S. Cl. CPC G10L 15/22; B60K 37/06; B60R 16/0373; G10L 2015/228; B60K 2350/1044

(57) ABSTRACT

In a method for the proactive guidance of an information system with a user, information potentially to be transmitted to the user by the information system, which is built into a vehicle or another mobile technical system, passes through a relevance and/or plausibility check based on contextual knowledge about the user and, on detection of information to be transmitted, the information system proactively initiates a dialogue with the user. A corresponding system is also described.

The invention relates to a method and a corresponding information system for proactive dialogue guidance of an information system, wherein information to be potentially transmitted to the user passes through a relevance and plausibility check based on contextual knowledge about the user.

Vehicles are increasingly distinguished by the fact that they are able to interact with technical systems with an occupant, especially a driver. Man-machine interaction systems (MMI) are increasingly used for this purpose, which supply information to a respective user. A transfer of information can be difficult for several reasons. On the one hand, a lot of information is available to such information systems via connections to external data sources, such as the Internet, of which only a subset is of interest to the respective user. On the other hand, in particular in an interaction with a driver, date and type of the information transmission is crucial, because overlays in the visual perception area of the driver (popups) can irritate the driver and contribute to a traffic hazard.

DE 10 2007 045 147 A1 discloses a tachograph which presents various warnings and error messages in a different way than via an optical overlay. For this purpose, a speech sequence is created, which contains references to the error messages or warnings. DE 10 2007 045 147 A1 also discloses a device for outputting information. This device has a control unit with a plurality of applications and an optical display medium for presenting information, wherein a subset of the information is classified as important. An assessment of whether information is classified as important is performed by a filter arranged on a control unit.

DE 102 07 993 A1 discloses a traffic information system for use in vehicles which receives traffic related data, correlated these data according to predetermined criteria, sorts the combined data by relevance and then provides these data to a respective driver by way of means for passing on information. The criteria used to analyze the data and sort them with respect to relevance can, on the one hand, be fixedly defined, or can be completely or in part defined individually by the respective driver.

DE 10 2010 051 833 A1 discloses a method and apparatus which may be used for interaction of a vehicle with a user, wherein the device includes at least one input device, at least one evaluation device and at least one output device, wherein at least one state information and at least one follow-up state are assigned to an initial state, wherein a change is made from an initial state to a subsequent state, if a transition condition specific for the subsequent state is satisfied in the initial state, wherein a user input can be entered via the at least one input device, wherein the at least one user input can be evaluated with the evaluation device in the initial state, wherein the at least one subsequent-state-specific transition condition is fulfilled for the of the initial state, if the evaluated user input matches at least one predetermined user input, wherein after the change in the subsequent state, the state information assigned to the subsequent state can be outputted with the at least one output device.

Against the background of the prior art, it is now an object of the present invention to assist a user by initiating a dialogue in such a way that the user is not distracted by irrelevant information while still being provided with user-relevant information.

This object is achieved by a method having the features of independent claim 1 and by an information system having the features of independent claim 7. Additional advantageous features are recited in the respective dependent claims.

In a method of the aforementioned type for interacting with a user, this object is solved with the invention in that the information to be potentially proactively transmitted to the user by the information system according to the invention passes through a relevance and plausibility check based on contextual knowledge about the user.

According to the invention, a method for proactive dialogue guidance of an information system with a user is provided, wherein information to be potentially transmitted to the user from the information system, which is integrated in a vehicle or in another mobile technical system, passes through a relevance and/or plausibility check based on contextual knowledge about the user, and the information system proactively initiates a dialogue with the user upon detection of information to be transmitted.

An interaction initiated proactively, i.e. by the information system according to the invention, can support the user if information relevant to the user is provided. In contrast to conventional methods, such as popup windows which appear unsolicited and without a possibility for the user to intervene, the method according to the invention initially now checks the information to be potentially transmitted to the user before transmission and/or display of relevant information. This check takes place with regard to plausibility and relevance. Since a particular provided item of information does not appear equally plausible or equally relevant for each user, it is advantageous for meaningful proactive dialogue guidance, as provided by the invention, to respond to a context of each user and to perform a relevance and plausibility check of information to be potentially transmitted depending on this context. The information system according to the invention can acquire the knowledge about the context of the respective user from all technically feasible means, for example, via an input from the respective user, through provision by a service employee, from digital information systems or the like. The contextual knowledge may also be stored in an appropriate manner in a storage unit and be available for the information system. The storage unit can also be part of the information system. If an item of information was checked for plausibility and relevance and was found to be relevant and plausible, then this item of information can be used to proactively get in touch with the user. The information can be displayed on a display or transmitted to the user in an acoustically perceptible fashion.

Relevant information in the context of the method and of the information system according to the invention is to be understood as including all information that appears relevant for a particular user in its respective context, i.e. supports the respective user in his plans and/or planned actions, or provides the respective user with additional facts that could be important in a particular situation now or in the future. Such information includes, in particular, traffic data, weather data, data about the condition of the respective vehicle, messages and general news about important events, announcements and news about events impacting the user as well as communication with other people or systems.

Contextual knowledge about a user in the context of the method and information system according to the invention is to be understood as data that provide information about plans and intended actions of the respective user. These may include, in particular, data about the driving style, preferred places of interest, regular patterns of activity, as well as data concerning interests and a preferred social environment. Furthermore, data relating to a personality profile of the respective user may be used in order to fine-tune the relevance test to the user.

The relevance test unburdens the user, because he will not be bothered with or distracted by information irrelevant for him.

In another possible embodiment of the method according to the invention, the proactively initiated dialogue of the information system provided according to the invention with the user may be conducted in the form of language.

According to an embodiment of the inventive method, the proactive dialogue may be initiated in the form of a verbal question.

An example of such a proactive interaction could be: “May I provide you with information about the next inspection interval?” The user can react as he wishes and accept or reject the request, preferably by a spoken reaction. The reaction by the user may be in spoken form or by operating suitable input means.

Distractions, for example by visual overlays, are to be avoided especially in road traffic. An interaction on based on speech only slightly affects the attention of the user, in particular the driver of a vehicle, and corresponds additionally to the preferred method of interaction between people. The user can quickly absorb the information transmitted to him and respond appropriately and in his own way, i.e. he may optionally also reject the information to be provided. The question that is according to the present invention for example verbally expressed may also be answered in a form other than speech, e.g. by operating a mechanical or electronic device, such as a steering column switch or the like.

To enable a user, in particular the driver of a vehicle, to use the provided information in a self-determined fashion, an opportunity for the driver to interact and, if necessary, intervene must be guaranteed in the communication of information by the information system provided by the invention. The user of the information system should be able to control the information offered to him and thereby control its own attentiveness. This intervention is made possible according to the invention, as described above, in that the information transmission is started with a question, which the user can reject and thereby cancel or delay the interaction. The user can thus create a self-determined information management in interaction with the information system.

Furthermore, it is possible to intervene with the inventive method in a controlling fashion already in advance of the interaction. By transmitting or providing contextual information to the inventively provided information system for example by the user, the relevance check can block information even before contact with the user is initiated. For example, the user may inform the information system that he is “stressed” at this moment, so that a very close relevance check is performed by the inventive process and only very high-priority information is passed on to the user.

According to another embodiment of the inventive method, a response from the user to the initiation of the proactively initiated dialogue with the user by the inventively provided information system may be used as an information basis for controlling additional steps of the information system.

If the user is available to receive information in the situation and if he agrees to the interaction, then he responds positively to the proactive initiation by the information system provided according to the invention. In one embodiment of the method according to the invention, inputs from the user formulated in response to the opening question may be evaluated and subsequent steps may be matched to this entry.

In order to serve the user as a perfect assistant, it is necessary to continuously receive the latest information and to transmit this information to the user provided it is relevant and plausible. The relevance and plausibility is checked depending on contextual knowledge of the information system about the user. In other words, the information available for transmission to the user is filtered so as to provide maximum support for each user in the respective context. The context of the respective user may depend, for example, on his age, social status, medical history, deadlines, etc.

In another possible embodiment of the method according to the invention, information relevant for the user may be transmitted to the inventively provided information system by or via at least one of the following information carriers or information channels: optical disk data carrier, storage medium, network, especially wireless network, radio link, input via an operating element, input via speech.

In order to serve the user as an assistant and to relieve the user through upstream relevance and plausibility checks, it is necessary that the user can rely on the information that is found to be relevant and plausible and forwarded to the user. Accordingly, the information should also cover respective interests of the user and do not leave any information gaps, which would cause the user to search independently and thus negate the relief, Therefore, in another embodiment, it seems sensible for the inventive method to access an information pool that makes all relevant information available. This may be accomplished, for example, with a link to the Internet.

According to another possible embodiment of the inventive method, processes for controlling the inventively provided information system may run in the background, i.e. unnoticed by the user. In other words, a supply with and an analysis of information of potential relevance to the user may with the inventive method run in the background, meaning unnoticed by the user. Due to execution in the background, both the user and the inventively provided information system can act and react from any context of the MMI (Navigation, Phone, Media . . . ). For example, information to be transmitted can be transmitted, when required, from an output via a smartphone to a vehicle display, as long as the vehicle display is operatively connected to the information system, without requiring the dialog with the information system to be interrupted. The execution of the method according to the invention in the background allows modifications of the underlying process steps and/or calculations independent of the user. Furthermore, an output mode can then be changed from for, example, a man-machine interface of a vehicle to a mobile phone or the like.

The present invention further relates to an information system to proactive dialogue guidance with a user guide. The information system according to the invention is used in particular to carry out the inventive method.

The information system according to the invention is configured such that information to be potentially transmitted by the information system to the user initially passes a relevance and/or plausibility check based on contextual knowledge about the user. The information system includes at least the following components: a microphone configured to receive acoustic commands, a speech output device for acoustic signals, a computing element which is configured to perform calculations necessary for the plausibility and/or relevance check, and a receiving unit for receiving information potentially relevant for the driver.

To ensure a high quality user support, technical requirements must be met, which are attained according to the invention by the present information system. These include a microphone to transmit voice commands of the user to the information system, a speech output device to verbally interact with the user, and a computing element, which carries out the necessary processing operations, such as the calculations underlying the plausibility and relevance check. Lastly, a display unit may be provided to display information to be transmitted to the driver. This display unit, for example, a screen or a display may be part of the information system, but must be at least in operative contact with the information system.

Furthermore, according to a possible embodiment, the information system of the invention is or may be installed in a vehicle. Support of the user and in particular the driver is particularly useful especially in road traffic, since there is little time for distracting, information-generating processes.

According to another possible embodiment of the information system according to the invention, information to be transmitted to the driver, for example, in response to an affirmative answer by the user to a question posed in the context of a proactive interaction initiated by the information system, may be reproduced by optical and/or acoustic signal transducers. Here, for example, a traffic situation for a route specified by the user may be outputted via a loudspeaker and in support also displayed on a screen. This means that acoustic information, which is usually issued in the form of speech, can be reproduced by a loudspeaker and/or by other suitable sound generator.

In addition to the interaction by voice, it may in some cases make sense to visualize information of interest in order to thereby transmit the information to the user more targeted and also more quickly and more efficiently. Especially in road traffic, the transmission of route information exclusively by voice means is rather more disturbing than helpful. This can be avoided by displaying the information also on a visual display unit having the type TFT, LCD, tube, plasma, LED or any other technically suitable optical display unit.

In the method according to the invention for proactive dialogue guiding of the type described above, the object of supporting a user by initiating a dialogue so that his attention is not distracted by irrelevant information while still being supplied with the relevant information, is attained by passing the information to be potentially proactively transmitted to the user by the inventively provided technical information system through a relevance and plausibility check based on contextual knowledge about the user.

The inventive method discloses a process step, which proactively creates a dialogue with a user, i.e. before an operation by the user. Systems that forward information to the respective users without an intervention of or a request from the respective user are already known; however, these conventional systems lack an opportunity to intervene, i.e. to reject the reproduction, by way of commands, in particular through voice commands by the user.

A proactive dialogue guide, as realized in the present method according to the invention, is used to support of the user, in particular the driver of a vehicle, by providing relevant and plausible information. It is hereby not necessary to go through a cascade of sequelae in response to a user input, like in the disclosure of DE 10 2010 051 833 A1. Instead, it must be evaluated whether information is both plausible and relevant for a transmission, so that for better service the user is not burdened by a preselection. Therefore, the present inventive method is optimized so that relevant information is transmitted to the user even without intervention or involvement of the user while still being attuned to his context. A meaningful division into relevant or irrelevant information can only be achieved in conjunction with contextual knowledge.

It will be understood that the features mentioned above and the features yet to be explained can be used not only in the particular indicated combination, but also in other combinations or severally, without departing from the scope of the present invention.

The invention is schematically illustrated in the drawing with reference to an embodiment and will be described schematically and in detail with reference to the drawings.

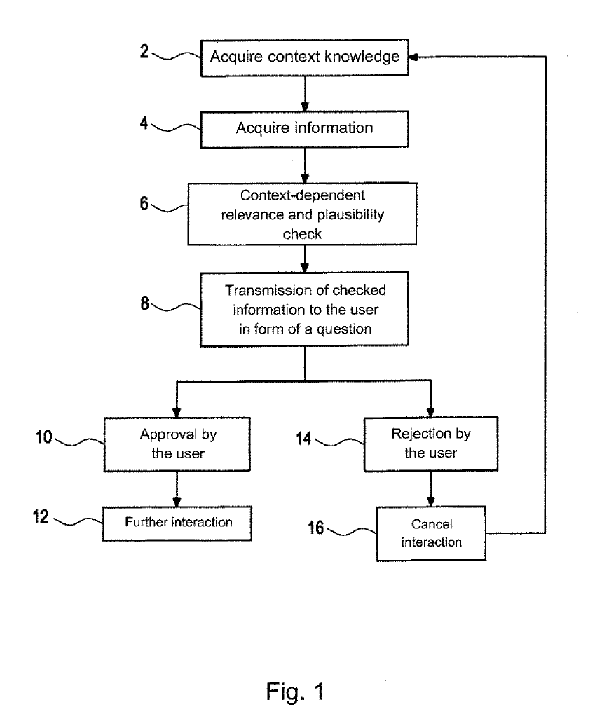

FIG. 1 shows a flow diagram of an embodiment of the inventive method.

In one embodiment of the inventive method, as shown in FIG. 1, a user of a vehicle wants to travel his morning commute in his vehicle. For this purpose, the user enters the vehicle, in which an embodiment of the information system according to the invention is installed, which is activated automatically by the user entering the vehicle or by an operator action by the user. Due to an input by the user made in advance, as shown in step 2, information relating to the route to the workplace, which is likely chosen by the user, is generated. Via traffic radio, as shown in step 4, the information system according to the invention receives the information that unfavorable traffic conditions, such as congestion, exist on the route to the workplace. This information is according to the invention evaluated according to the criteria of plausibility and relevance, as shown in step 6. If the information is rated to be plausible and relevant, a dialog in the form of a question is proactively started, as shown in step 8.

While still in the garage, the information system poses the question to the user whether he wishes to be supplied with the latest traffic information. If the response from the user is positive, for example, by expressing his verbal consent, as shown in step 10, this information is presented to him with a focus on the route to the workplace, as shown in Step 12. If the response from the user is negative, as shown in step 14, the dialog is aborted or postponed, and started again at a later time, as shown in step 16.

The user is also able to adapt his original plan based on the new information and to park the vehicle in favor of public transport. To this end, another embodiment of the inventive method may be executed on a mobile device, for example a mobile phone, allowing the user to be supplied via the mobile device with the new information customized for the situation. Thus, for example an application for planning the trip using public transport can be started by the process of the invention, as shown in step 12.

1.-8. (canceled)

9. A method for proactive dialogue guidance of an information system with a user, comprising:
passing information that is potentially to be transmitted to the user from the information system, which is integrated in a vehicle or in another mobile technical system, through a relevance or a plausibility check, or both, based on contextual knowledge about the user, and
initiating with the information system proactively a dialogue with the user upon detection of information to be transmitted.

10. The method of claim 9, wherein the proactively initiated dialog of the information system with the user is performed in form of speech.

11. The method of claim 10, wherein the proactively initiated dialog of the information system with the user is started by a question.

12. The method of claim 11, wherein a response by the user to the proactive initiation of the dialogue by the information system with the user is used as an information base for controlling additional method steps performed by the information system.

13. The method of claim 9, wherein information relevant for the user is transmitted to the information system by or via at least one of the following information carriers or information channels: optical data carrier, storage medium, network, especially wireless network, radio link, input via an operating element, input via language.

14. The method of claim 9, wherein processes controlling the information system are carried out in the background and not noticed by the user.

15. An information system for proactive dialogue guidance with a user, comprising at least the following operatively connected components:
a microphone configured to receive acoustic commands,
a speech output device for acoustic signals,
a computing element configured to perform necessary calculations necessary for a plausibility or a relevance check, or both, and
a receiving unit for receiving information of potential relevance for the driver,
wherein the information system is configured such that information to be potentially transmitted to the user from the information system passes the relevance check or the plausibility check, or both, based on contextual knowledge about the user.

16. The information system of claim 15, wherein information, which was determined based on a response from the user, or information based on a proactive dialogue initiated by a question of the information system, is reproduced by optical and/or audible signal transducers.
